(19) United States
(12) Patent Application Publication
(10) Pub. No.: US 2024/0095597 A1
(43) Pub. Date: Mar. 21, 2024

(54) Method for Generating Additional Training Data for Training a Machine Learning Algorithm

(71) Applicant: Robert Bosch GmbH, Stuttgart (DE)

(72) Inventors: Eitan Kosman, Haifa (IL); Amulya Hiremath, Bangalore (IN); Barbara Rakitsch, Stuttgart (DE); Gonca Guersun, Stuttgart (DE); Joerg Wagner, Renningen (DE); Michael Herman, Sindelfingen (DE); Yu Yao, Herzogenrath (DE)

(21) Appl. No.: 18/469,166

(22) Filed: Sep. 18, 2023

(30) Foreign Application Priority Data
Sep. 19, 2022 (DE) 10 2022 209 844.7

(51) Int. Cl. G06N 20/00

(52) U.S. Cl. CPC G06N 20/00

(57) ABSTRACT

A method for generating additional training data for training a machine learning algorithm is disclosed. The method includes (i) providing training data for training the machine learning algorithm, wherein the training data includes labeled sensor data from at least one sensor, (ii) transforming the training data for training the machine learning algorithm in a graph structure, wherein nodes in the graph structure represent objects represented in the corresponding sensor data, and wherein a starting node of the graph structure represents the position of the at least one sensor with respect to the objects represented in the corresponding sensor data, and (iii) generating additional training data for training the machine learning model by modifying the graph structure.

This application claims priority under 35 U.S.C. § 119 to patent application no. DE 10 2022 209 844.7, filed on Sep. 19, 2022 in Germany, the disclosure of which is incorporated herein by reference in its entirety.

The present disclosure relates to a method for generating additional training data for training a machine learning algorithm, wherein additional training data can simply be generated by slightly transforming known training data based on a graph-structure.

### BACKGROUND

Machine learning algorithms build a model based on sample data, respectively training data in order to make predictions or decisions without being explicitly programmed to do so.

Machine learning algorithms are used in a wide variety of applications, for example autonomous driving and driving assistance applications. In autonomous driving and driving assistance applications, one main task is to predict how likely each possible driving task, for example lane keeping or a lane change, is at a given point of time. For a given vehicle, such prediction task requires a probabilistic inference framework that takes a set of measured features, for example velocity, relative position with respect to lanes, and potentially also the driving task of the vehicle at previous point of times as input. The framework then solves a classification problem and outputs the likelihood of each driving task at the current point of time. Finally, the classification output can be used as input for autonomous driving functions or driving assistance application functions, for example an adaptive cruise control, to improve driving comfort and to avoid safety issues.

Usually, a huge amount of training data is required to train these machine learning algorithms. Further, in autonomous driving and driving applications, such a machine learning algorithm should be able to very accurately predict possible driving tasks, in order to avoid safety issues. However, capturing all possible situations during training is very hard, wherein a lot of storage space for storing training data that represents all possible situations and a lot of computing resources to train the machine leaning algorithm based on training data that represents all possible situations would be required. Therefore, there is a need for an improved method for providing training data respectively additional training data for training a machine learning algorithm.

Document US 2021/073660 A1 discloses a method for training a machine learning algorithm using data augmentation of training data, wherein training data including data instances and class labels is accessed, wherein the class labels represent classes from a set of classes, and wherein the machine learning algorithm is trained using the training data, wherein the training includes augmenting the training data by obtaining a variable from a pseudorandom or deterministic process, deriving a new data instance of the training data by modifying, in a manner which is dependent on the variable, the data instance to obtain the new data instance, determining a prediction target label for the new data instance using a conditionally invertible function having as input a class label of the data instance and the variable, and using the new data instance and the prediction target label in the training of the machine learning model.

It is an object of the present disclosure to provide an improved method for providing training data respectively additional training data for training a machine learning algorithm.

This object is solved by the method for generating additional training data for training a machine learning algorithm according to the disclosure set forth below.

This object is further solved by the system for generating additional training data for training a machine learning algorithm according to the disclosure set forth below.

### SUMMARY

According to one embodiment of the disclosure, this object is solved by a method for generating additional training data for training a machine learning algorithm, wherein training data for training the machine learning algorithm is provided, wherein the training data includes labeled sensor data from at least one sensor, wherein the training data is transformed into a graph structure, wherein nodes in the graph structure represent objects represented in the corresponding sensor data, and wherein a starting node of the graph structure represents the position of the at least one sensor with respect to the objects represented in the corresponding sensor data, and wherein additional training data for training the machine learning model is generated by modifying the graph structure.

Here, a sensor is a device, module, machine, or subsystem that detects events or changes in its environment and sends the information to other electronics, frequently a computer processor. Further, labeled sensor data is data acquired by a sensor to which one or more meaningful and informative labels have been added to provide context so that a machine learning algorithm can learn from it.

Further, a graph structure consists of a finite set of nodes, respectively vertices or points, together with a set of pairs of these nodes. A starting node is further a node based on which respectively starting from which the graph structure is built.

That objects are represented in the sensor data further means that the objects can be detected in the corresponding sensor data.

Thus, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data.

Further, by using a graph structure to generate the additional training data, the training data can be quantified and simplified, respectively the additional training data be generated based on simple operations, without that resource intensive adaptions would be required.

Therefore, an improved method for providing training data respectively additional training data for training a machine learning algorithm is provided.

The step of providing training data for training the machine learning algorithm from at least one sensor can comprise acquiring sensor data by the at least one sensor and labeling the acquired sensor data based on features respectively characteristics of objects represented in the acquired sensor data, to generate the training data for training the machine learning algorithm.

That the acquired sensor data is labeled means that one or more meaningful and informative labels are added to the sensor data to provide context so that the machine learning algorithm can learn from it.

Thus, the method for generating additional training data for training a machine learning algorithm can take into account features apart from the data processing equipment on which the method is carried out, respectively the generation of the additional training data is determined from features apart from the data processing equipment on which the method is carried out.

In one embodiment, the step of generating additional training data for training the machine learning algorithm by modifying the graph structure comprises dropping at least one node of the graph structure.

That at least one node is dropped from the graph structure means that at least one node is completely removed from the graph structure, wherein the at least one node is preferably an object node, respectively a node representing an object, and not the starting node.

By dropping at least one node from the graph structure, scenarios can be simply created that simulate the absence of information respectively information about objects, for example undetected vehicles. Thereby, reasonable scenarios that should be included in the training data, for example in order to avoid safety issues, can be generated based on known training data and included in the training of the machine learning algorithm.

The step of generating additional training data for training the machine learning algorithm by modifying the graph structure can further comprises adding a perturbation to at least one node of the graph structure.

That a perturbation is added to at least one node of the graph structure means that at least one feature of at least one object, for example the position of the at least one object, and therefore also the position of the node that represents the at least one object is slightly changed, wherein the at least one node is preferably an object node and not the starting node.

By adding a perturbation to at least one node of the graph structure, scenarios can be simply created that simulate situations where noise is included in acquired sensor data, what leads to an uncertainty when generating outputs based on the acquired sensor data by the machine learning algorithm. Thereby, reasonable scenarios that should be included in the training data, for example in order to avoid safety issues, can be generated based on known training data and included in the training of the machine learning algorithm.

The step of generating additional training data for training the machine learning algorithm by modifying the graph structure can also comprise mirroring at least a part of the graph structure.

That at least a part of the graph structure means is mirrored means that the position of at least two objects in one dimension, and therefore, also the position of the nodes that represent these objects in one dimension is switched, respectively mirrored, wherein these nodes preferably are object nodes and do not include the starting node. For example, when the machine learning algorithm is trained to be used for driving task recognition, lanes of a road, and therefore, also the position of vehicles respectively driving on these lanes can be switched, respectively mirrored.

By mirroring at least a part of the graph structure, scenarios can be simply created that simulate data similar but mirrored behavior, what leads to an uncertainty when generating outputs based on the acquired sensor data by the machine learning algorithm. Thereby, reasonable scenarios that should be included in the training data, for example in order to avoid safety issues, can be generated based on known training data and included in the training of the machine learning algorithm.

The step of generating additional training data for training the machine learning algorithm by modifying the graph structure can also comprise masking at least one feature of at least one object represented in the corresponding acquired sensor data.

That at least one feature of at least one object represented in the corresponding acquired sensor data is masked means that at least one feature of at least one object represented in the corresponding acquired sensor data is set to zero, respectively zeroed out.

By masking at least one feature of at least one object represented in the corresponding acquired sensor data scenarios can be simply created that simulate situations, where some information is not available respectively absent in the acquired data, respectively was not available at the point of time at which the data was acquired. Thereby, reasonable scenarios that should be included in the training data, for example in order to avoid safety issues, can be generated based on known training data and included in the training of the machine learning algorithm.

The step of generating additional training data for training the machine learning algorithm by modifying the graph structure can also comprise duplicating at least one node in the graph structure.

That at least one node is duplicated in the graph structure is duplicated means that the at least one node appears twice in the graph structure, wherein the at least one node is preferably an object node and not the starting node.

By duplicating at least one node in the graph structure scenarios can be simply created that simulate situations, where the system thinks that there are two objects, although there is only one object. Thereby, reasonable scenarios that should be included in the training data, for example in order to avoid safety issues, can be generated based on known training data and included in the training of the machine learning algorithm.

Furthermore, the step of generating additional training data for training the machine learning algorithm by modifying the graph structure can also comprise moving the starting node of the graph structure.

That the starting node of the graph structure is moved means that a distance between the starting node and the other nodes of the graph structure is respectively adapted.

By moving the starting node scenarios can be simply created that simulate situations, wherein the ego object, respectively the object on which the at least one sensor is arranged, has an influence on other objects. Thereby, reasonable scenarios that should be included in the training data, for example in order to avoid safety issues, can be generated based on known training data and included in the training of the machine learning algorithm.

According to another embodiment of the disclosure, a method for training a machine learning algorithm is provided, wherein the method comprises providing training data for training the machine learning algorithm, generating additional training data for training the machine learning algorithm by a method for generating additional training data for training a machine learning algorithm as described above, and training the machine learning algorithm based on the training data and the additional training data.

Thus, a method for training a machine learning algorithm based on additional training data generated by an improved method for providing additional training data for training a machine learning algorithm is provided. Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data. Further, by using a graph structure to generate the additional training data, the training data can be quantified and simplified, respectively the additional training data be generated based on simple operations, without that resource intensive adaptions would be required.

According to still another embodiment of the disclosure, a method for controlling a controllable function of a vehicle based on a machine learning algorithm is provided, wherein the method comprises providing a machine learning algorithm for controlling the controllable function, wherein the machine learning algorithm is trained by a method for training a machine learning algorithm as described above, and controlling the controllable function based on the trained machine learning algorithm.

Here, a controllable function of a vehicle is a function of a vehicle, which output can be controlled, or which can be controlled in such a way, that a state of a part or system can move from any state zo any other state in finite time, or that facilitates controllability in the behavioral framework of the vehicle.

Thus, a method for controlling a controllable function of a vehicle based on a machine learning algorithm that is trained based on additional training data generated by an improved method for providing additional training data for training a machine learning algorithm is provided. Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data. Further, by using a graph structure to generate the additional training data, the training data can be quantified and simplified, respectively the additional training data be generated based on simple operations, without that resource intensive adaptions would be required. Further, by controlling a controllable function of a vehicle based on a correspondingly trained machine learning algorithm, the driving comfort when driving the vehicle can be increased.

Therein, the controllable function can for example be an adaptive cruise control of an autonomous driving vehicle.

According to still a further embodiment of the disclosure, a system for generating additional training data for training a machine learning algorithm is provided, wherein the system is configured to execute a method for generating additional training data for training a machine learning algorithm as described above.

Thus, an improved system for providing additional training data for training a machine learning algorithm is provided. Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data. Further, by using a graph structure to generate the additional training data, the training data can be quantified and simplified, respectively the additional training data be generated based on simple operations, without that resource intensive adaptions would be required. Further, by controlling a controllable function of a vehicle based on a correspondingly trained machine learning algorithm, the driving comfort when driving the vehicle can be increased.

According to still a further embodiment of the disclosure, a system for training a machine learning algorithm is provided, wherein the system comprises a providing unit, wherein the providing unit is configured to provide training data for training the machine learning algorithm, a system for training additional training data for training the machine learning algorithm as described above, wherein the system for training additional training data is configured to generate additional training data for training the machine learning algorithm based on the training data, and a training unit, wherein the training unit is configured to train the machine learning algorithm based on the training data and the additional training data.

Thus, a system for training a machine learning algorithm based on additional training data generated by an improved system for providing additional training data for training a machine learning algorithm is provided. Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data. Further, by using a graph structure to generate the additional training data, the training data can be quantified and simplified, respectively the additional training data be generated based on simple operations, without that resource intensive adaptions would be required.

According to still a further embodiment of the disclosure, a control unit for controlling a controllable function of a vehicle based on a machine learning algorithm is provided, wherein the control unit comprises a providing unit, wherein the providing unit is configured to provide a machine learning algorithm for controlling the controllable function, wherein the machine learning algorithm is trained by a system for training a machine learning algorithm as described above, and a control unit, wherein the control unit is configured to control the controllable function based on the trained machine learning algorithm.

Thus, a control unit for controlling a controllable function of a vehicle based on a machine learning algorithm that is trained based on additional training data generated by an improved system for providing additional training data for training a machine learning algorithm is provided. Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data. Further, by using a graph structure to generate the additional training data, the training data can be quantified and simplified, respectively the additional training data be generated based on simple operations, without that resource intensive adaptions would be required. Further, by controlling a controllable function of a vehicle based on a correspondingly trained machine learning algorithm, the driving comfort when driving the vehicle can be increased.

Therein, the controllable function can again for example be an adaptive cruise control of an autonomous driving vehicle.

According to still another embodiment of the disclosure, a computer program that comprises instructions which, when the program is executed by a computer, cause the computer to execute a method for generating additional training data for training a machine learning algorithm as described above is provided.

According to still another embodiment of the disclosure, a computer-readable medium having stored thereon a computer program as described above is provided.

Therein, the computer program and the computer-readable medium respectively have the advantage, that they are configured to execute an improved method for providing additional training data for training a machine learning algorithm. Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data. Further, by using a graph structure to generate the additional training data, the training data can be quantified and simplified, respectively the additional training data be generated based on simple operations, without that resource intensive adaptions would be required. Further, by controlling a controllable function of a vehicle based on a correspondingly trained machine learning algorithm, the driving comfort when driving the vehicle can be increased.

### BRIEF DESCRIPTION OF THE DRAWINGS

The disclosure will now be described in further detail with reference to the attached drawings.

FIG. 1. illustrates a method for generating additional training data for training a machine learning algorithm according to embodiments of the disclosure;

FIG. 2a-d illustrate embodiments of the step of generating additional training data for training the machine learning model by modifying the graph structure;

FIG. 3. Illustrates a system for generating additional training data for training a machine learning algorithm.

### DETAILED DESCRIPTION

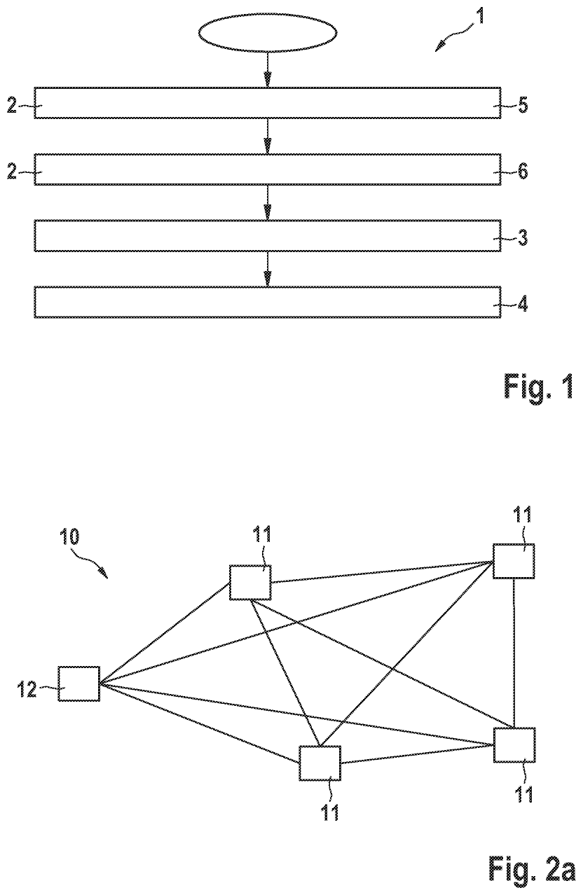

FIG. 1 illustrates a method for generating additional training data for training a machine learning algorithm 1 according to embodiments of the disclosure.

Machine learning algorithms, for example neural networks, trained on large amounts of data have proven superior in many tasks. Among these tasks is the driving task recognition. For this purpose, one has to perform a tedious process of data collection and annotation. One technique that mitigates this is data augmentation, which is used for enriching the training dataset by transforming data samples in such a way, that the transformed samples mimic valid samples that have not existed in the original dataset.

FIG. 1 illustrates a method 1, wherein training data for training the machine learning algorithm is provided in a first step 2, wherein the training data includes labeled sensor data from at least one sensor, wherein the training data is transformed into a graph structure in a step 3, wherein nodes in the graph structure represent objects represented in the corresponding sensor data, and wherein a starting node of the graph structure represents the position of the at least one sensor with respect to the objects represented in the corresponding sensor data, and wherein additional training data for training the machine learning model is generated by modifying the graph structure in a step 4.

Therein, reasonable scenarios that should be included in the training data for training a machine learning algorithm, for example reasonable scenarios that should be included in the training data in order to avoid safety issues can be generated based on known training data using data augmentation techniques, respectively techniques used to increase the amount of data by adding slightly modified copies of already existing data. Therefore, a smaller set of training data can be used and required storage space be saved, wherein required additional training data can be generated by slightly modifying known training data.

Further, by using a graph structure to generate the additional training data, the training data can be quantified and simplified, respectively the additional training data be generated based on simple operations, without that resource intensive adaptions would be required.

Therefore, an improved method 1 for providing training data respectively additional training data for training a machine learning algorithm is provided.

In particular, FIG. 1 illustrates a method 1 that enriches the training dataset and covers new scenes and improves generalization and reduces the bias of the machine learning algorithm.

The machine learning algorithm can for example be a neural network, for example a neural network that is trained to perform driving task recognition based on corresponding labeled data, wherein training the neural network can comprise optimizing the weights of the neural network.

As shown in FIG. 1, the step 2 of providing training data for training the machine learning algorithm from at least one sensor comprises a step 5 of acquiring sensor data by the at least one sensor and la step 6 of labeling the acquired sensor data based on features of objects represented in the acquired sensor data, to generate the training data for training the machine learning algorithm.

Therein, the at least one sensor can be mounted to a vehicle and the corresponding data can be acquired during test drives with the vehicle. In particular real-world data from a real vehicle can be recorded and thereafter annotated respectively labeled.

Further, the at least one sensor can be configured to record data over a particular amount of time, wherein the at least sensor can for example be a video sensor, and wherein the method can comprise an additional step of sampling sliced sequences from the recorded data, wherein the sliced sequences are then respectively augmented. For example, the sliced sequences can for example respectively have a duration of 5s, wherein the at least one sensor has recorded data over 1 h.

According to the embodiments of FIG. 1, one or more of a set of predefined augmentation techniques can be used to augment the data.

Therein, the set of predefined augmentation techniques comprises dropping at least one node of the graph structure.

Further, the set of predefined augmentation techniques comprises adding a perturbation to at least one node of the graph structure.

The set of predefined augmentation techniques also comprises mirroring the graph structure.

Furthermore, the set of predefined augmentation techniques comprises masking at least one feature of at least one object represented in the corresponding acquired sensor data.

According to the embodiments of FIG. 1, the set of predefined augmentation techniques comprises duplicating at least one node in the graph structure.

Further, the set of predefined augmentation techniques comprises moving the starting node of the graph structure.

The method 1 provides a set of data augmentations that generate data samples that have not existed in the originally collected dataset, wherein the data augmentations can then be directly used to train a machine learning algorithm, for example a machine learning algorithm that is trained to perform driving task recognition.

Therein, during operation of a corresponding vehicle, the output of the machine learning algorithm that is trained to perform driving task recognition can then for example be used as input to control a controllable function of the vehicle, for example an adaptive cruise control.

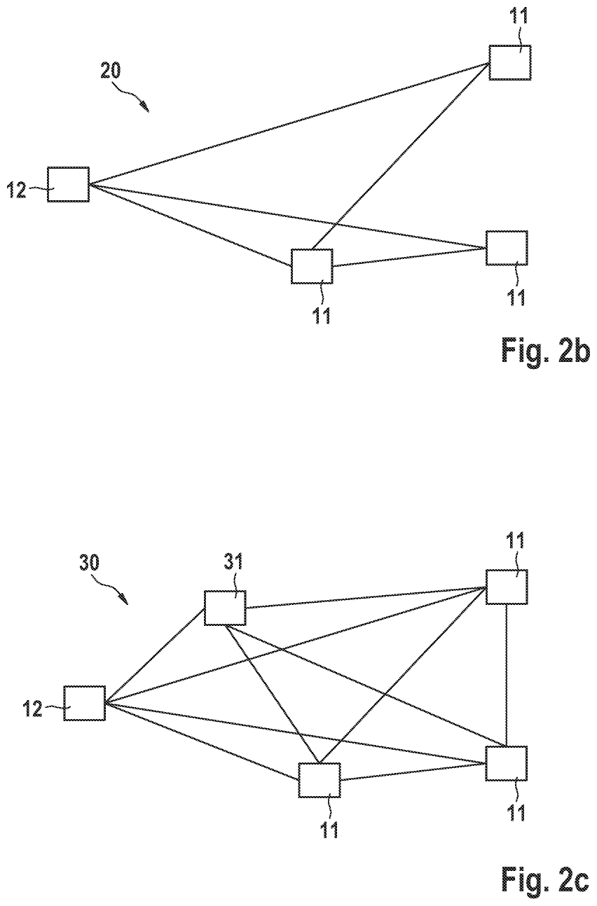

FIG. 2a-d illustrate embodiments of the step of generating additional training data for training the machine learning model by modifying the graph structure.

In particular, FIG. 2a illustrates a graph structure 10 generated based on training data for training a machine learning algorithm, wherein the training data includes labeled sensor data from at least one sensor.

Therein, nodes 11 of the graph structure correspond to respectively represent objects represented in the corresponding sensor data. Further, a starting node 12 represents the position of the at least one sensor with respect to the objects represented in the corresponding sensor data.

In the embodiment shown in FIG. 2a, each node 11 of the graph structure 10 is respectively connected to each other node 11 of the graph structure and the starting node by an edge.

For example, the training data can be acquired during test drives with a vehicle, wherein the graph structure represents a scene on a road acquired during the test drives.

FIG. 2b illustrates modifying the graph structure by dropping at least one node of the graph structure.

In particular, FIG. 2b shows a modified graph structure 20 that has been generated based on the graph structure shown in FIG. 2a by removing a node and the corresponding edges from the graph structure.

FIG. 2c illustrates modifying the graph structure by adding a perturbation at least one node of the graph structure.

In particular, FIG. 2b shows a modified graph structure 30 that has been generated based on the graph structure shown in FIG. 2a by changing the position of one node 31 in the graph structure.

FIG. 2d illustrates modifying the graph structure by mirroring a part of the graph structure, respectively switching at least two nodes 41 of the graph structure.

In particular, FIG. 2b shows a modified graph structure 40 that has been generated based on the graph structure shown in FIG. 2a by switching the position of two nodes 41 in one dimension.

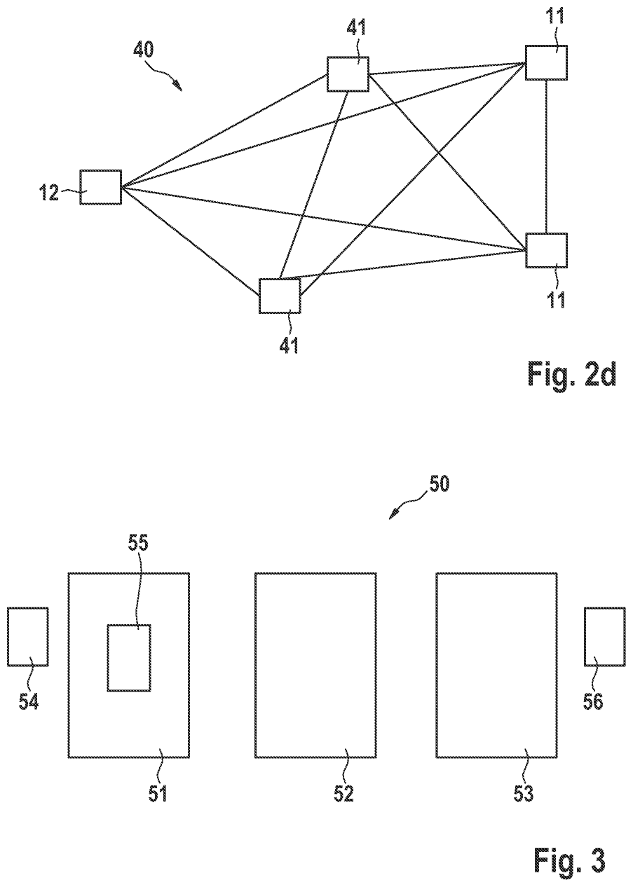

FIG. 3 illustrates a system for generating additional training data for training a machine learning algorithm 50 according to embodiments of the disclosure.

As shown in FIG. 2, the system 50 comprises a providing unit 51 that is configured to provide training data for training the machine learning algorithm, wherein the training data includes labeled sensor data from at least one sensor, a transforming unit 52 that is configured to transform the training data into a graph structure, wherein nodes in the graph structure represent objects represented in the corresponding sensor data, and wherein a starting node of the graph structure represents the position of the at least one sensor with respect to the objects represented in the corresponding sensor data, and a generating unit 53 that is configured to generate additional training data for training the machine learning algorithm by modifying the graph structure.

Therein, the providing unit can for example be a receiver for receiving corresponding sensor data. The transforming unit and the generating unit can for example be realized by code that is stored in a memory and executable by a processor.

According to the embodiments shown in FIG. 2, the system further comprises at least one sensor 54 for acquiring sensor data, wherein the providing unit comprises a labeling unit 55 that is configured to label the acquired sensor data based on features of objects represented in the acquired sensor data, to generate the training data for training the machine learning algorithm.

Therein, the at least one sensor can for example be a video sensor mounted to a vehicle.

The shown system 10 further comprises a data storage 56 in which code to perform pre-defined augmentation techniques is stored, wherein the pre-defined augmentation techniques are used by the generating unit 53 to generate the additional training data.

According to the embodiments of FIG. 2, the set of predefined augmentation techniques again comprises dropping at least one node of the graph structure, adding a perturbation to at least one node of the graph structure, mirroring at least a part of the graph structure, masking at least one feature of at least one object represented in the corresponding acquired sensor data, duplicating at least one node in the graph structure, and moving the starting node of the graph structure.

Further, the shown system 10 is configured to execute a method for generating additional training data for training a machine learning algorithm as described above.

What is claimed is:

1. A method for generating additional training data for training a machine learning algorithm, comprising:
providing training data for training the machine learning algorithm, wherein the training data includes labeled sensor data from at least one sensor;
transforming the training data for training the machine learning algorithm in a graph structure, wherein nodes in the graph structure represent objects represented in the corresponding sensor data, and wherein a starting node of the graph structure represents the position of the at least one sensor with respect to the objects represented in the corresponding sensor data; and
generating additional training data for training the machine learning model by modifying the graph structure.

2. The method according to claim 1, wherein the step of providing training data for training the machine learning algorithm from at least one sensor comprises:
acquiring sensor data by the at least one sensor; and
labeling the acquired sensor data based on objects represented in the acquired sensor data to generate the training data for training the machine learning algorithm.

3. The method according to claim 1, wherein the step of generating additional training data for training the machine learning algorithm by modifying the graph structure comprises:
dropping at least one node of the graph structure.

4. The method according to claim 1, wherein the step of generating additional training data for training the machine learning algorithm by modifying the graph structure comprises:
adding a perturbation to at least one node of the graph structure.

5. The method according to claim 1, wherein the step of generating additional training data for training the machine learning algorithm by modifying the graph structure comprises:
mirroring at least a part of the graph structure.

6. The method according to claim 1, wherein the step of generating additional training data for training the machine learning algorithm by modifying the graph structure comprises:
masking at least one feature of at least one object represented in the corresponding acquired sensor data.

7. The method according to claim 1, wherein the step of generating additional training data for training the machine learning algorithm by modifying the graph structure comprises:
duplicating at least one node in the graph structure.

8. The method according to claim 1, wherein the step of generating additional training data for training the machine learning algorithm by modifying the graph structure comprises:
moving the starting node of the graph structure.

9. The method for training a machine learning algorithm, comprising:
providing training data for training the machine learning algorithm;
generating additional training data for training the machine learning algorithm by a method for generating additional training data for training a machine learning algorithm according to claim 1; and
training the machine learning algorithm based on the training data and the additional training data.

10. The method for controlling a controllable function of a vehicle based on a machine learning algorithm, comprising:
providing a machine learning algorithm for controlling the controllable function, wherein the machine learning algorithm is trained by a method for training a machine learning algorithm according to claim 9; and
controlling the controllable function based on the trained machine learning algorithm.

11. A system for generating additional training data for training a machine learning algorithm, wherein the system is configured to execute a method for generating additional training data for training a machine learning algorithm according to claim 1.

12. The system for training a machine learning algorithm, wherein the system comprises a providing unit, wherein the providing unit is configured to provide training data for training the machine learning algorithm, a system for training additional training data for training the machine learning algorithm according to claim 11, wherein the system for training additional training data is configured to generate additional training data for training the machine learning algorithm based on the training data, and a training unit, wherein the training unit is configured to train the machine learning algorithm based on the training data and the additional training data.

13. A control unit for controlling a controllable function of a vehicle based on a machine learning algorithm, wherein the control unit comprises a providing unit, wherein the providing unit is configured to provide a machine learning algorithm for controlling the controllable function, wherein the machine learning algorithm is trained by a system for training a machine learning algorithm according to claim 12, and a control unit, wherein the control unit is configured to control the controllable function based on the trained machine learning algorithm.

14. A computer program that comprises instructions which, when the program is executed by a computer, cause the computer to execute a method for generating additional training data for training a machine learning algorithm according to claim 1.

15. Computer-readable medium having stored thereon a computer program according to claim 14.
